(19) United States
(12) Patent Application Publication
(10) Pub. No.: US 2010/0168357 A1
(43) Pub. Date: Jul. 1, 2010

(54) Branched Ionomers with Metal Methacrylates as Comonomers

(75) Inventors: Olga Khabashesku, Houston, TX (US); Scott Cooper, Humble, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/346,729

(22) Filed: Dec. 30, 2008

(51) Int. Cl. C08F 230/04

(52) U.S. Cl. 526/241; 526/240

(57) ABSTRACT

A branched aromatic ionomer is prepared with a first monomer having an unsaturated moiety and a second monomer having an unsaturated moiety and an ionic moiety, wherein the ionic moiety comprises a polyvalent metal with a coordination number greater than its oxidation number. An example of the first monomer is styrene, and the product ionomer can be a variety of general purpose polystyrene. Examples of the second monomer are zirconium methacrylate and titanium methacrylate, which may be co-polymerized with at least 0.5 molar equivalents of methacrylic acid as an in-situ formed ionomeric crosslinker.

### CROSS-REFERENCE TO RELATED APPLICATIONS

Not applicable.

### FIELD

The present invention generally relates the production of polymer compounds and more particularly to the production of ionomer polymers.

### BACKGROUND

Polystyrene, such as general purpose polystyrene (GPPS) is made from styrene, a vinyl aromatic monomer that can be produced from aromatic hydrocarbons, for example those derived from petroleum. GPPS can be useful in a variety of applications, such as casing for appliances, molded into toys or utensils, or expanded to create foamed styrene. In most cases, GPPS is a hard and brittle plastic, however, the use of comonomers can alter its physical properties, for example, styrene can be copolymerized with polybutadiene to make SBS rubber. The resulting SBS polymer has more rubber-like qualities, such as elastomeric performance and abrasion resistance. Other polymers can also experience altered physical and mechanical properties when polymerized using comonomers.

### SUMMARY

Embodiments of the present invention generally include a branched ionomer that is the product of co-polymerizing a first monomer having an unsaturated alkyl moiety with a second monomer having an unsaturated moiety and an ionic moiety, wherein the ionic moiety comprises a polyvalent metal having a coordination number greater than its oxidation number. The first monomer can include an aromatic moiety and the product of the co-polymerization can be a branched aromatic ionomer.

The first monomer can be selected from the group consisting of styrene, alphamethyl styrene, t-butylstyene, p-methylstyrene, vinyl toluene, and mixtures thereof.

The second monomer can be an unsaturated carboxylic acid that has an ionic bond to a metal where the carboxylic acid is chosen from the group consisting of crotonic acid, itaconic acid, cinnamic acid, phenylcinnamic acid, α-methylcinnamic acid, undecylenic acid, methacrylic acid, and mixtures thereof.

The polyvalent metal can have a coordination number greater than its oxidation number and can be a tetravalent metal having a coordination number of 6. The metal can be selected from the group consisting of zirconium, titanium, hafnium, and mixtures thereof.

In one embodiment, the first monomer is styrene and the second monomer is a metal methacrylate. In another embodiment, the metal of the metal methacrylate is tetravalent and has a coordination number of 6. The metal may be zirconium, titanium, or hafnium.

In yet another embodiment, the second monomer is either zirconium methacrylate or titanium methacrylate, and the co-polymerization mixture has at least 0.5 molar equivalents of methacrylic acid. The additional methacrylic acid can take advantage of the metal's coordination number being larger than its oxidation number. Because of its high coordination number, the metal can form coordination complexes with the additional methacrylic acid. These coordination complexes can result in a highly branched ionomer product, such as a variety of general purpose polystyrene, which may have altered physical properties, such as higher melt strength.

In another embodiment, the invention is any article made from any of the above polymer products. The ionomer can be foamed and the foamed ionomer can be used to make an article.

An embodiment of the present invention is a process for preparing a branched ionomer by copolymerizing a first monomer comprising an unsaturated alkyl moiety and a second monomer comprising an ionic moiety and at least one unsaturated moiety, wherein the ionic moiety comprises a polyvalent metal having a coordination number greater than its oxidation number.

The second monomer can be a metal methacrylate, which can be dissolved in the first monomer prior to or at the time of the copolymerization. The second monomer can further include at least 0.5 molar equivalent of methacrylic acid.

An alternate embodiment of the present invention is a process of estimating the melt strength of a branched ionomer containing a polyvalent metal having a coordination number greater than its oxidation number by determining the linear relationship between the polyvalent metal loading and melt flow rate of the branched ionomer, determining the linear relationship between the polyvalent metal loading and melt strength of the branched ionomer, determining the linear relationship between the melt flow rate and melt strength of the branched ionomer, measuring the melt flow rate of a sample of the branched ionomer and estimating the melt strength of the branched ionomer sample from the linear relationship between the melt flow rate and melt strength of the branched ionomer.

### BRIEF DESCRIPTION OF DRAWINGS

FIG. 1 illustrates a coordination complex comprising Ti(IV) and methacrylic acid.

FIG. 2 illustrates UV-Vis spectra of polystyrene ionomers with Zr and Ti methacrylates.

FIG. 3 illustrates the relationship between melt flow rate and Zr ion concentration for ionomers of styrene and Zr(MA)₄/2MAA.

FIG. 4 illustrates the relationship between melt strength and Zr ion concentration for ionomers of styrene and Zr(MA)₄/2MAA.

FIG. 5 illustrates the relationship between melt strength and melt flow rate for ionomers of styrene and Zr(MA)₄/2MAA.

FIG. 6 illustrates the relationship between melt strength and Zn ion concentration for ionomers of styrene and ZnDMA.

FIG. 7 illustrates a possible process scheme for in-situ preparation of a metal-containing comonomer/acid.

### DETAILED DESCRIPTION

Embodiments of the present invention generally include a branched ionomer that includes a first comonomer having an unsaturated moiety co-polymerized with a second comonomer having an unsaturated moiety and an ionic moiety, wherein the ionic moiety comprises an anionic group and a cationic group, where the cationic group is polyvalent and has a coordination number greater than its oxidation number.

The first comonomer can have an unsaturated moiety and an aromatic moiety that when polymerized with the second comonomer can form a branched aromatic ionomer. For example, suitable monomers having an aromatic moiety and an unsaturated alkyl moiety may include monovinylaromatic compounds such as styrene as well as alkylated styrenes wherein the alkylated styrenes are alkylated in the nucleus or side-chain. Alphamethyl styrene, t-butylstyene, p-methylstyrene, and vinyl toluene are suitable monomers that may be useful for preparing branched aromatic ionomers. The monovinylaromatic compounds may be employed singly or as mixtures. In one embodiment, styrene is used exclusively as the first monomer. Any monomer having an aromatic moiety and an unsaturated alkyl moiety may be used to prepare the branched aromatic ionomers.

Polystyrene is in structure a long hydrocarbon chain with a phenyl group attached to every other carbon. It is formed via the polymerization of the monomer styrene. Polystyrene, such as GPPS, may be produced using comonomers. One group of comonomers is ionic comonomers. Ionic comonomers can be polymerized with styrene and other polymerizable compounds to make an ionomer. The term “ionomer” in the art of producing polymers is a polymer having covalent bonds between elements of the polymer chain and ionic bonds between the separate chains of the polymer. An ionomer is also known to be polymers containing inter-chain ionic bonding.

An ionomer is a polymer that contains nonionic repeating units and a small portion of ionic repeating units. Generally, the ionic groups make up less than 15% of the polymer. Thus, an ionomer contains both ionic and covalent bonds. Covalent bonds exist along the polymer backbone chains. Ionic groups are attached to the backbone chain at random intervals.

Ionic bonds exist between the ionized groups of different chains, forming crosslinks that are reversible. When heated, the ionic bonds are lessened and can be overcome, leading to the breaking of the crosslinks, and the polymer chains can move around. These reversible crosslinks give polystyrene viscoelastic behavior and elastomeric properties, such that the polymer can be less brittle and more resistant to abrasions. Ionic aggregates in the copolymer can also affect such properties as bending modulus, tensile strength, impact resistance, and melt viscosity.

One group of ionic comonomers that can be used to make a polystyrene ionomer is metal-containing comonomers, such as unsaturated carboxylic acid salts reacted with a metal oxide. Metal methacrylates are an example. Methacrylic acid contains an unsaturated carbon-carbon double bond that allows it to be incorporated into the polymer chain. Methacrylic acid also contains a carboxylic acid that can form ionic bonds with metal ions. Most metal ion use in crosslinking has been done using monovalent ions, such as alkali metals, and also with divalent ions, such as alkaline earth metals and transition metals like zinc. However, tetravalent metal ions, such as zirconium and titanium, can be useful in polystyrene and other ionomers to obtain physical properties such as high melt strength. It has been noted that metal ions of higher charges can bond to a higher number of methacrylic acids to enhance branching and crosslinking.

Increased branching and crosslinking may impart physical changes such as increased strength, higher temperature performance, and improved hardness. Tetravalent metal ions offer an advantage in that they may bond to four methacrylic acids to produce high melt strength and crosslinking density. Further, tetravalent metals such as zirconium, titanium and hafnium have vacant d-orbitals that give them a coordination number of 6. Thus, tetravalent transition metals like Zr, Ti and Hf may coordinate with up to six methacrylic acids to produce even higher melt strength and crosslinking density.

Because of their ability to form coordination complexes, it would be desirable to use tetravalent metal methacrylates with two molar equivalents of methacrylic acid as an in-situ formed ionomeric crosslinker in the production of polystyrene and other branched aromatic ionomers.

In one embodiment, a metal methacrylate is used as a comonomer. In another embodiment, the metal has a coordination number greater than its oxidation state. In another embodiment, the metal has a coordination number of 6 that allows for the formation of coordination complexes with methacrylate, which may increase polydispersity and melt strength. In another embodiment, two molar equivalents of MAA are added to a tetravalent metal methacrylate to increase formation of coordination complexes. Examples of tetravalent metals are zirconium, titanium and hafnium. These metal methacrylates may also be used in the production of other branched ionmers.

Because of its unsaturated moiety, a metal methacrylate can, like styrene, undergo free radical polymerization and thus be incorporated into the polystyrene chain. Because of its ionic moiety, a metal methacrylate can serve as an ionomeric crosslinker, the cationic metals forming reversible bridges to two or more anionic acid ends of methacrylates incorporated into the backbones of different chains. It should be noted that other unsaturated carboxylic acids, such as crotonic acid, itaconic acid, cinnamic acid, phenylcinnamic acid, a-methylcinnamic acid, undecylenic acid, and other similar acids can be used in place of methacrylic acid. The resulting ionomers can be evaluated for their melt strength, molecular weight, and crosslinking density, or polydispersity. Table 1 shows data for an embodiment where zirconium methacrylate is used as a comonomer with styrene. Table 1 shows data for when the molar ratio of zirconium (Zr) to methacrylate (MA) is 1 to 4 and 1 to 6.

TABLE 1
Melt strength, molecular weight and melt flow rate data for ionomers
formed with Zr(MA)₄ and Zr(MA)₆ complexes.

| | Zr loading | | | | | | |
|---|---|---|---|---|---|---|---|
| | per 200 g of | | | | | | |
| Molar ratio | Styrene | Melt Flow | Melt | | | | |
| Zr to MA | mmol | Index¹ g/10 min | Strength, N | Mn, ×10³² | Mw, ×10³² | Mz, ×10³² | Polydispersity³ |
| 1 to 4 | 0.5 | 0.853 | 0.089 | 132 | 335 | 663 | 2.5 |
| 1 to 6 | 0.5 | 0.449 | —* | 132 | 339 | 711 | 2.6 |

*sample broke at exit of extruder
¹ASTM D-1238 g/10 min, 200 C./5 kg, October 2001
²ASTM D-6474
³Mz/Mn

Table 2 shows data for an embodiment where titanium methacrylate is used as a comonomer with styrene. Table 2 shows data for when the molar ratio of titanium (Ti) to methacrylate (MA) is 1 to 1, 1 to 2, 1 to 4, and 1 to 6.

TABLE 2
Melt strength, molecular weight and melt flow rate data for ionomers
formed from Ti(OEt)₄ and methacrylic acid mixture.

| | Ti loading | | | | | | |
|---|---|---|---|---|---|---|---|
| | per 200 g of | Melt Flow | | | | | |
| Molar ratio | Styrene | Index¹ | Melt | | | | |
| Ti to MA | mmol | g/10 min | Strength, N | Mw, ×10³² | Mz, ×10³² | Polydispersity³ | Tg ° C.⁴ |
| 1 to 1 | 0.5 | 1.682 | 0.030 | 289 | 463 | 2.30 | 108.2 |
| 1 to 2 | 0.5 | 1.324 | 0.039 | 299 | 494 | 2.40 | 108.4 |
| 1 to 4 | 0.5 | 1.407 | 0.040 | 273 | 475 | 2.40 | 109.0 |
| 1 to 6 | 0.5 | 1.146 | 0.051 | 288 | 494 | 2.50 | 108.4 |

¹ASTM D-1238 g/10 min, 200 C./5 kg, October 2001
²ASTM D-6474
³Mz/Mn
⁴ASTM D-3418, C., DSC Inflection (Mid) Point, July 1999

Tables 1 and 2 both show a general increase in melt strength and decrease in melt flow rate as more methacrylate is included. This trend continues even as the molar ratio of methacrylate to metal becomes higher than the metal valence number. This data suggests that Zr and Ti are capable of forming coordination complexes with methacrylate. Comparison of the melt strength and melt flow parameters of Ti⁴⁺ and Zr⁴⁺ ionomers in Tables 1 and 2 shows that at the same metal content, Zr gives higher melt strength/lower melt flow polymer and appears to cause higher crosslinking density than Ti. Zirconium has a larger radius than titanium, which may help accommodate coordination of more MA groups.

In transition metal alkoxides, the oxidation state of a metal is a smaller number than its coordination number. For Ti, Zr and Hf, the oxidation state is 4, while the coordination number is 6. Thus, the metal tends to use its vacant d-orbital to accept oxygen lone pairs from other acid residues of the copolymer chains and form charge transfer complexes.

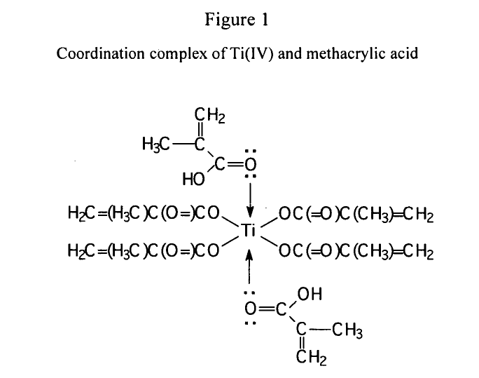

FIG. 1 shows an example of a charge transfer complex with a titanium metal center. A charge transfer complex with a zirconium metal center would appear similar. The metal center has ionic bonds with the ionized acidic end of four methacrylates. Two additional methacrylic acids coordinate with the metal center by donating oxygen lone pairs to the vacant d-orbital of the metal and forming a charge transfer complex. A charge transfer complex is defined as an electron donor-electron acceptor complex, characterized by electronic transition to an excited state. This excited state produces an observable color change. Almost all charge transfer complexes have unique and intense absorption bands in the ultraviolet-visible region. Thus, the formation of coordination complexes with Ti and Zr can be confirmed with UV-Vis spectra.

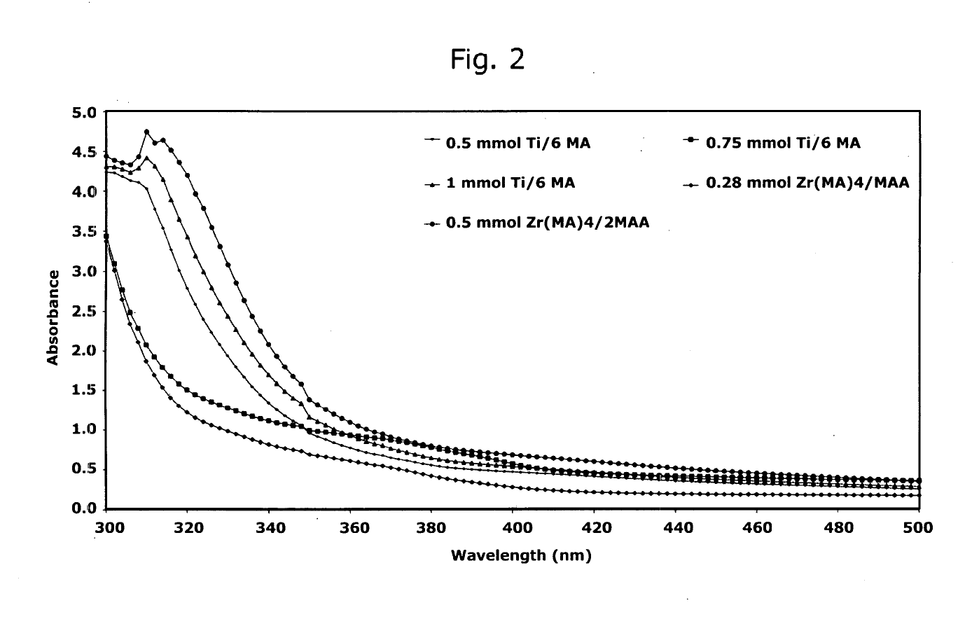

In one embodiment of the present invention, zirconium methacrylate complex with two molar equivalents of methacrylic acid is added to styrene and copolymerized to create an ionomer with viscoelastic properties and high melt strength. As an example, 2.32 mmol (1 g) of zirconium methacrylate (Zr(MA)₄) was dissolved in 5 ml styrene monomer to form a clear colorless solution. 4.64 mmol (0.399 g) of methacrylic acid (MAA) was added to the solution, producing a slight yellowish color. The color change indicates the formation of charge transfer complexes. A UV-Vis spectrum was taken to confirm the formation of charge transfer complexes. FIG. 2 shows the UV-Vis spectra of polystyrene ionomers with Zr and Ti methacrylates at a molar ratio of 6 MAA to 1 metal. The arrows in FIG. 2 show absorption peaks due to the charge transfer between metal ions and carbonyl groups in methacrylic acid below 360-370 nm.

Nine aliquots of the above solution containing from 0.090 to 0.500 mmol of Zr was added to 200 g of styrene in a polymerization kettle and copolymerized. Crystal grade polystyrene was made by batch polymerizations at 131° C. with 170 ppm of LUPERSOL® 233 catalyst (L-233) as initiator. Metal containing comonomers are added to the polymerization vessel in solution form. Table 3 presents the melt flow rates and melt strength measurements for the nine samples.

TABLE 3
Melt Strength and Melt flow rate of Zr⁴⁺ ionomers prepared by
copolymerization with in-situ formed complex Zr(MA)₄/2MAA.

| Zr(IV) loading | Zr(IV) loading | | | |
|---|---|---|---|---|
| mmol | ppm | MFI | | Tg |
| per 200 g of St | of Zr(MA)4 | g/10 min | Melt Strength N | ° C. |
| 0.090 | 194 | 2.05 | 0.032 | 111.8 |
| 0.125 | 270 | 1.71 | 0.028 | 111.1 |
| 0.200 | 432 | 1.51 | 0.05 | 111.4 |
| 0.250 | 539 | 1.48 | 0.049 | 111.1 |
| 0.280 | 604 | 1.13 | 0.075 | 111.9 |
| 0.300 | 647 | 1.06 | 0.075 | 111.4 |
| 0.350 | 755 | 1.18 | * | 111.9 |
| 0.400 | 863 | 1.21 | * | 112.3 |
| 0.500 | 1079 | 0.45 | * | |

* sample broke at exit of extruder

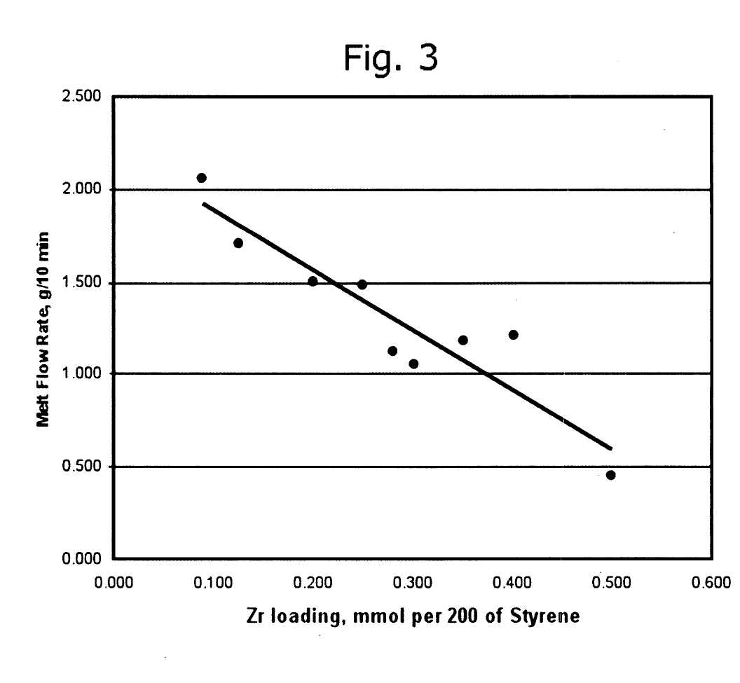

Table 3 shows that melt flow rate consistently decreased with increasing loading of Zr(IV). FIG. 3 shows the linear relationship between melt flow rate of the ionomer and Zr ion concentration. The x-axis shows Zr loading in mmol per 200 g of styrene. The y-axis shows the melt flow rate in grams per 10 minutes.

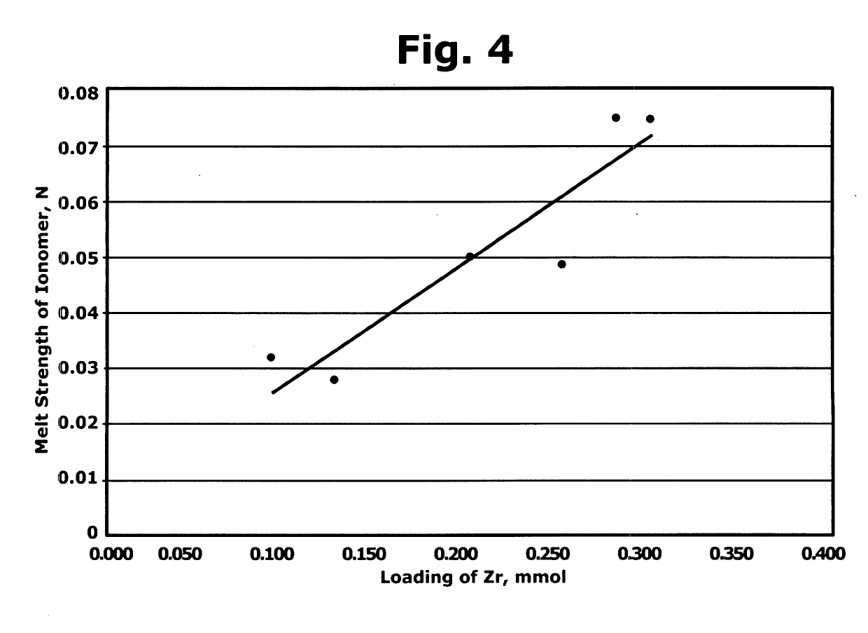

FIG. 4 plots the relationship between melt strength of the ionomer and Zr ion concentration. As seen in both Table 3 and FIG. 4, melt strength consistently increases with higher loading of Zr(IV). The x-axis shows Zr loading in mmol per 200 g of styrene. The y-axis shows melt strength in N.

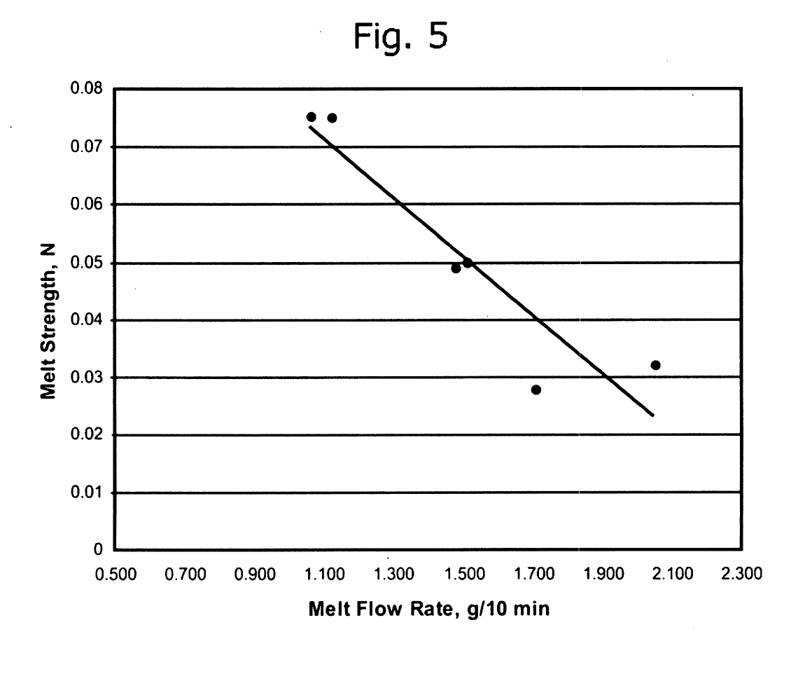

Because Zr loading exhibits a linear relationship with both melt flow rate and melt strength, melt flow rate can be measured and used to predict melt strength. FIG. 5 plots the relationship between melt strength and melt flow rate, with melt flow rate on the x-axis and melt strength on the y-axis. Established linear dependence of melt strength on melt flow rate allows melt strength estimation by fast and simple melt flow rate measurement tests. An embodiment of the present invention is a method of estimating the melt strength of a branched ionomer containing a polyvalent metal having a coordination number greater than its oxidation number. The method includes determining the linear relationship between the polyvalent metal loading and melt flow rate of the branched ionomer, determining the linear relationship between the polyvalent metal loading and melt strength of the branched ionomer, and then determining the linear relationship between the melt flow rate and melt strength of the branched ionomer. The melt flow rate of a sample of the branched ionomer can be measured the melt strength of the branched ionomer sample estimated from the linear relationship between the melt flow rate and melt strength of the branched ionomer that had been determined.

In-situ prepared complex of zirconium methacrylate with two molar equivalents of methacrylic acid can be a highly efficient ionomeric crosslinker of polstyrene. The comonomer of the Zr(MA)₄/2MAA works in several ways to create a highly crosslinked ionomer with altered physical properties. A first way is through the formation of covalent bonds due to the unsaturated moieties of the methacrylate. A second way is through the formation of a bridge, which may occur when a polyvalent (or as is the case for Zr and Ti, tetravalent) cation coordinates to two or more anionic methacrylate groups which are integrated into the backbones of at least two separate chains. In effect, the separate chains may become bridged; the more bridges, the higher the crosslinking density. Another way is via hydrophilic-hydrophobic interactions. The comparatively non-polar portions of the ionomer such as the polystyrene backbones are mutually attracted and also mutually repelled from the polar ionic portions of the ionomer. All these interactions can affect the primary, secondary, and tertiary structure of the ionomer, altering melt strength, polydispersity, and glass transition temperature.

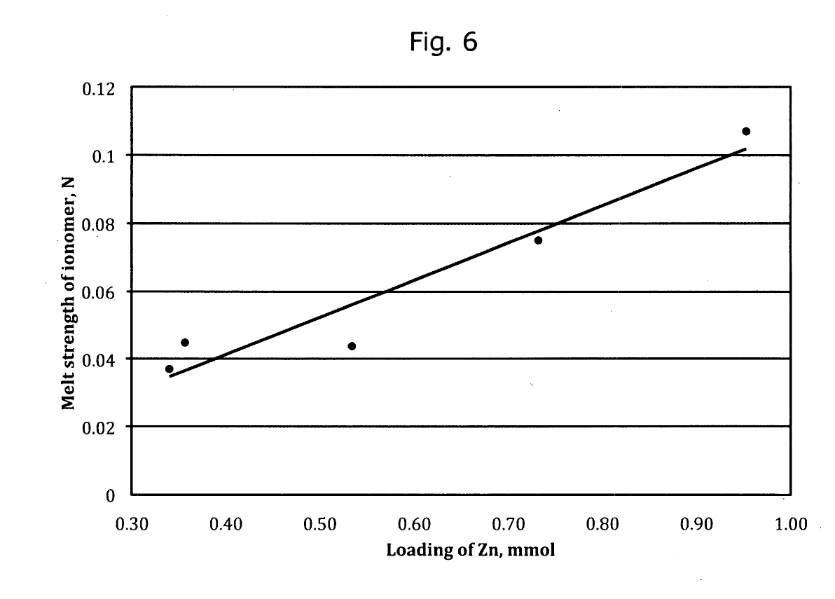

Batch polymerization of styrene in the presence of zinc dimethacrylate carried out under like conditions as for the preparation of zirconium containing ionomers can be used for comparison. As seen from FIGS. 4 and 6, a loading of approximately 0.57 mmol of zinc (as dimethacrylate) gives a melt strength of 0.06 N while a loading of approximately 0.25 mmol of zirconium (as methacrylate) gives a melt strength of 0.06 N. A loading of approximately 0.40 mmol of zinc gives a melt strength of 0.04 N while a loading of approximately 0.16 mmol of zirconium gives a melt strength of 0.04 N. As less than half the molar amount of zirconium is needed as compared to zinc to achieve the same melt strength, zirconium can be considered a more efficient metal center for ionomer type of crosslinking than zinc. Table 4 presents the melt flow rates and melt strength measurements for the zinc dimethacrylate loadings.

TABLE 4
Melt Strength and Melt flow rate of Zn ionomers prepared by
copolymerization with ZnDMA.

| | | |
|---|---|---|
| ZnDMA loading | Melt Strength | MFI |

| ppm | mmol* | N | g/10 min |
|---|---|---|---|
| 400 | 0.34 | 0.037 | 1.48 |
| 419 | 0.36 | 0.045 | 1.45 |
| 629 | 0.53 | 0.044 | 1.29 |
| 861 | 0.73 | 0.075 | 0.94 |
| 1120 | 0.95 | 0.107 | 0.7 |

*mmol of ZnDMA per 200 g batch of styrene monomer

FIG. 6 shows the melt strength versus molar Zn loading per 200 g batch of styrene monomer.

Zirconium (IV) metharylate based complex has been shown to form polystyrene ionomers with 2.0-2.5 times higher melt strength than ionomers prepared with equal molar concentration of Zn (II) methacrylate. Zirconium methacrylate complex with 2 molar equivalents of MAA has been shown to be more than 2 times more efficient than Zn²⁺ of zinc methacrylate, therefore it takes less zirconium ions than zinc ions to achieve the same melt strength.

Geometry of the ionic aggregates may be an important determinant of crosslinking ability. In another embodiment, zirconyl methacrylate, ZrO(MA)₂, can be used as an ionic comonomer with styrene to impart high melt strength. The addition of two molar equivalents of MAA, however, does not lead to higher melt strength, as is generally the case for zirconium and titanium. Table 5 presents melt strengths, melt flow rates, and glass transition temperatures for samples of ZrO(MA)₂ containing 1 to 4 and 1 to 6 molar ratios of Zr to MA.

TABLE 5
Melt Strength and Melt flow rate and Tg for PS ionomers formed
with Zirconyl methacrylate

| Molar | Zr loading per | | | |
|---|---|---|---|---|
| ratio Zr to | 200 g of | Melt Flow | | |
| MA | styrene mmol | g/10 min | Tg, ° C. | Melt Strength, N |
| 1 to 4 | 0.5 | 1.072 | 113.76 | 0.082 |
| 1 to 6 | 0.5 | 1.734 | 112.35 | 0.032 |

According to Table 5, additional MA did not increase melt strength, but in fact, decreased it. Thus, zirconium may have a geometry that better suits the formation of coordination complexes with methacrylic acid than does zirconyl methacrylate. According to X-ray crystallography, the geometry of zirconium complexes is generally octahedral. Thus, other ionic comonomers with octahedral geometry may also be used to impart the same high melt strengths in the production of GPPS.

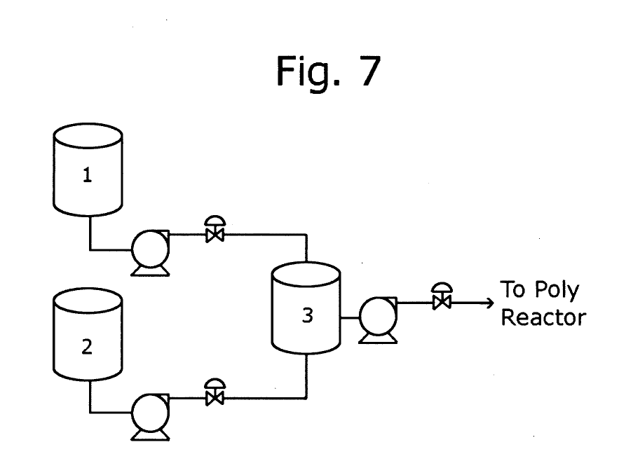

FIG. 7 illustrates a possible process scheme for in-situ preparation of a metal-containing comonomer/acid complex. Metal-containing precursor solution is prepared in the vessel 1 and mixed in the vessel 3 with the acrylic acid, transported from the vessel 2. Any process for preparing GPPS can be used to prepare the ionomer. Also, any additive known to be useful to those of ordinary skill in the art of preparing ionomers may be used.

Use of broader terms such as comprises, includes, having, etc. should be understood to provide support for narrower terms such as consisting of, consisting essentially of, comprised substantially of, etc.

The term “ionomer” is a polymer having covalent bonds between elements of the polymer chain and ionic bonds between the separate chains of the polymer. An ionomer can also be polymers containing inter-chain ionic bonding.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A branched ionomer comprising the product of co-polymerizing a first monomer comprising an unsaturated alkyl moiety with a second monomer comprising an unsaturated moiety and an ionic moiety, wherein the ionic moiety comprises an anionic group and a cationic group, wherein the cationic group comprises a polyvalent metal having a coordination number greater than its oxidation number.

2. The branched ionomer of claim 1, wherein the first monomer further comprises an aromatic moiety and the product of the co-polymerization is a branched aromatic ionomer.

3. The branched aromatic ionomer of claim 2, wherein the first monomer is selected from the group consisting of styrene, alphamethyl styrene, t-butylstyene, p-methylstyrene, vinyl toluene, and mixtures thereof.

4. The branched aromatic ionomer of claim 2, wherein the first monomer comprises styrene.

5. The branched ionomer of claim 1, wherein the second monomer is an unsaturated carboxylic acid that has an ionic bond to a metal where the carboxylic acid is chosen from the group consisting of crotonic acid, itaconic acid, cinnamic acid, phenylcinnamic acid, a-methylcinnamic acid, undecylenic acid, methacrylic acid, and mixtures thereof.

6. The branched ionomer of claim 1, wherein the cationic group is a polyvalent metal having a coordination number greater than its oxidation number.

7. The branched ionomer of claim 1, wherein the cationic group is a tetravalent metal having a coordination number of 6.

8. The branched ionomer of claim 6, wherein the metal is selected from the group consisting of zirconium, titanium, hafnium, and mixtures thereof.

9. The branched ionomer of claim 1, wherein at least 0.5 molar equivalent of methacrylic acid is added to the comonomers.

10. The branched ionomer of claim 5, wherein the second monomer comprises a metal methacrylate.

11. The branched ionomer of claim 10, wherein the metal methacrylate is selected from the group consisting of zirconium methacrylate, titanium methacrylate, hafnium methacrylate, and mixtures thereof.

12. The branched ionomer of claim 10, wherein the second monomer comprises a metal methacrylate with at least 0.5 molar equivalent of methacrylic acid.

13. An article made from the branched ionomer of claim 1.

14. The branched ionomer of claim 1, wherein the ionomer is foamed, and wherein the foamed ionomer is used to make an article.

15. A process for preparing a branched ionomer comprising copolymerizing a first monomer comprising an unsaturated alkyl moiety and a second monomer comprising an ionic moiety and at least one unsaturated moiety, wherein the ionic moiety comprises an anionic group and a cationic group, wherein the cationic group comprises a polyvalent metal having a coordination number greater than its oxidation number.

16. The process of claim 15, wherein the monomers are admixed prior to or at the time of the copolymerization.

17. The process of claim 15, wherein the second monomer is prepared in-situ in the first monomer.

18. The process of claim 15, wherein the second monomer comprises a metal methacrylate.

19. The process of claim 18, wherein the second monomer is prepared by dissolving a metal methacrylate in the first monomer prior to or at the time of the copolymerization.

20. The process of claim 18, wherein the second monomer further comprises at least 0.5 molar equivalent of methacrylic acid.

21. The process of claim 18, wherein the second monomer is prepared by dissolving a metal methacrylate and at least 0.5 molar equivalent of methacrylic acid in the first monomer prior to or at the time of the copolymerization.

22. The process of claim 18, wherein the metal methacrylate is selected from the group consisting of zirconium methacrylate, titanium methacrylate, hafnium methacrylate, and mixtures thereof.

23. A process of estimating the melt strength of a branched ionomer containing a polyvalent metal having a coordination number greater than its oxidation number comprising:
determining the linear relationship between the polyvalent metal loading and melt flow rate of the branched ionomer;
determining the linear relationship between the polyvalent metal loading and melt strength of the branched ionomer;
determining the linear relationship between the melt flow rate and melt strength of the branched ionomer;
measuring the melt flow rate of a sample of the branched ionomer; and
estimating the melt strength of the branched ionomer sample from the linear relationship between the melt flow rate and melt strength of the branched ionomer.
